(19) United States
(12) Patent Application Publication
(10) Pub. No.: US 2003/0173454 A1
(43) Pub. Date: Sep. 18, 2003

(54) All terrain aircraft (ATA)

(76) Inventor: Paul Brown, Ft. Lauderdale, FL (US)

Correspondence Address: PAUL BROWN, 7405 N.W. 52ND ST, LAUDERHILL, FL, 33319, US

(21) Appl. No.: 10/097,825

(22) Filed: Mar. 14, 2002

(51) Int. Cl. B64C 37/02; B64D 5/00

(52) U.S. Cl. 244/2

(57) ABSTRACT

By air, land and sea. Extending the function and performance of a multi-function aircraft.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO SEQUENCE LISTING, A TABLE, OR A COMPUTER PROGRAM LISTING COMPACT DISK APPENDIX

Not applicable.

### BACKGROUND OF THE INVENTION

This invention is relevant to aircraft propulsion and steering on water and land, also to the field of lifting fuselages finally to the field of amphibious aircraft.

No true all terrain aircraft (ATA) category exist. There are aircrafts designed to land on water and land (amphibians), others designed to land on unimproved runways as well as conventional runways with possible tundra tires, referred to as bush planes. There is no aircraft that is both an amphibian and a bush plane.

Amphibians are divided into two main categories, aircrafts that are adapted to removable floats, aircraft with Fuselage designed as float (Flying boat). Flying boats have the advantage of a lower drag and center of gravity, boasting as a result improved top end speed and stability on water. Small flying boats, typically having lower wings than dock heights are difficult to dock. Where not only does the impact of the aircraft with the dock cause dents and nicks. Additionally it's near impossible to get out without getting wet. The wings prevent the passenger side of aircraft to reach the dock. Navigating in a docking area is tedious. If like most amphibians reverse thrust turbo propeller is not available. A wooden paddle is quit commonplace awkward primitive solution to line aircraft with docking area or with the direction of current for takeoff. Also relevant background, flying boats are prone to have a longer takeoff run on water contributed to by greater surface area of aircraft in contact with water. Taxing on the intercostals or near bystanders there is the problem of the high contrail wind generated and the spinning propeller being a safety hazard, its also produces much more noise than boats, this limits the use of flying boats in peaceful community where the lake could also be a park.

Hover aircrafts are extended amphibians utilizing expensive and technical hovercraft technology can land gently on water and land however low ground clearance makes this unsuitable for surfaces that are not relatively flat or smooth.

Bush planes are most commonly tail-draggers over tricycle gear, where oversized tires are placed on the two front positions. Two large tundra tires create less drag than 3. A tricycle gear with a nose-wheel instead of a tail wheel means an increase in loading and hence size. And there is always the possibility in uneven terrain that the nose wheel touches down first, one wheel bearing the weight of entire touchdown loads results in typical structural failure of these setups. Landing gear will have a tendency to sink and stick in to loose soil on touchdown if the wheels are not large enough in area to support the inertial forces plus weight of aircraft. Due to positioning of landing gear common bush plane will have a tendency to fatally nose over if wheels sink and stick especially for tail-draggers. Additionally tail-draggers create visibility problems on takeoff for the pilot in terms of seeing the runway and possible disaster spots, due to pitch angle. And does not allow pilots to flare on touchdown, to reduce landing distance.

A fixed wing aircraft is simpler and safer to fly than a helicopter, and the inherent speed advantage is the main reason why fixed wing aircrafts outnumber all other aircrafts significantly. Short takeoff and landing (STOL) aircraft technology has constantly tried to reduce the takeoff run of a fixed wing aircraft. Swing-wings, leading edge slats and combination flaps can be heavy and technical solution to increasing STOL without limiting small aircraft top end speed. If a fixed wing aircraft can achieve acceptable STOL capability in comparison to tilt-rotors and gyroplane, it would make all the same redundant. Only a fixed wing aircraft can fly nap of the earth at speeds approaching the speed of sound. Speed and proximity to ground brings the relevant background of aircraft collision safety.

Forward impact resistance is under tests by the government to determine and improve aircraft crash survivability. Automobile safety standards governed by law mandates this, however aircrafts still can fly legally without offering passengers impact protection even comparable to an automobile that has a slower speed. While its true front impact is not the only way an aircraft can crash and that at certain speeds nothing can protect occupants, this is also true for automobiles. This is the most likely scenario of unforced errors due to environmental conditions and or pilot incompetence. The primitive safety standards of aircrafts have turned minor cash impacts into countless tragedies.

It is my observation that engines are getting lighter, more powerful and smaller. With the current availability of an 18 horsepower outboard engine that weighs only approximately 85 lbs, even without thought for aircraft adaptation. Also true for aircraft engines, these engines will allow the increase of the useful load of aircrafts without increasing gross weight and STOL capability.

### BRIEF SUMMARY OF THE INVENTION

In-cockpit altering aircraft, an all terrain flying machine, it is my objective to not only extend the function of a multipurpose aircraft but also to improve the existing roles to which this aircraft pertains and fulfills.

### BRIEF DESCRIPTION OF THE SEVERAL VIEWS OF THE DRAWING

FIG. 1 is a perspective of aircraft landing gear extended.

FIG. 2 is a perspective of aircraft landing gear retracted.

FIG. 3 is an exploded view of aircraft.

FIG. 4 is a bottom view of aircraft

FIGS. 5A-5B is sections of hull of aircraft

FIG. 6 is top plan view of aircraft with twin outboard propeller system

FIG. 7 is rear elevation with single engine outboard propeller system.

FIG. 8 is side elevation of aircraft.

FIG. 9 is a front perspective of aircraft

FIGS. 10A-10B is an illustration depicting mounting and replacing outboard propeller system.

FIG. 11A section showing that both outboard propeller system and cap should have the same cross sectional aerodynamic profile.

FIG. 11B shows a cross section through engine head, showing more aerodynamic cover.

FIGS. 12A-12B is a perspective of main landing gear extending and retracting in pods.

FIG. 13 section trough pod intersecting wing, sandwiching a slot.

FIG. 14 section through nose wheel and actuating members.

FIGS. 15A-15B show blended wheel body, aerodynamic profile

FIGS. 16A-16C illustrates a nose-wheel under different force scenarios.

FIGS. 17A-17C illustrates a main landing gear under different force scenarios.

FIG. 18. Is a front elevation main landing gear illustrating varying tire size on same axle.

FIG. 19 shows a rounded profile nose-wheel with central rib, where only central rib.

FIG. 20 is a cross section through hub to show secondary wheel rotate-able around the hub.

FIG. 21 is a schematic side view of nose wheel, illustrating chambers.

FIGS. 22A-22B is a series of partial cross section through hub to explain means for suspension and overrides.

FIGS. 23A-23B illustrates use of outboard propeller as auxiliary power for takeoff.

FIGS. 24A-24B illustrates splash deflector.

FIG. 25 a perspective of how to use side step.

### DETAILED DESCRIPTION OF THE INVENTION

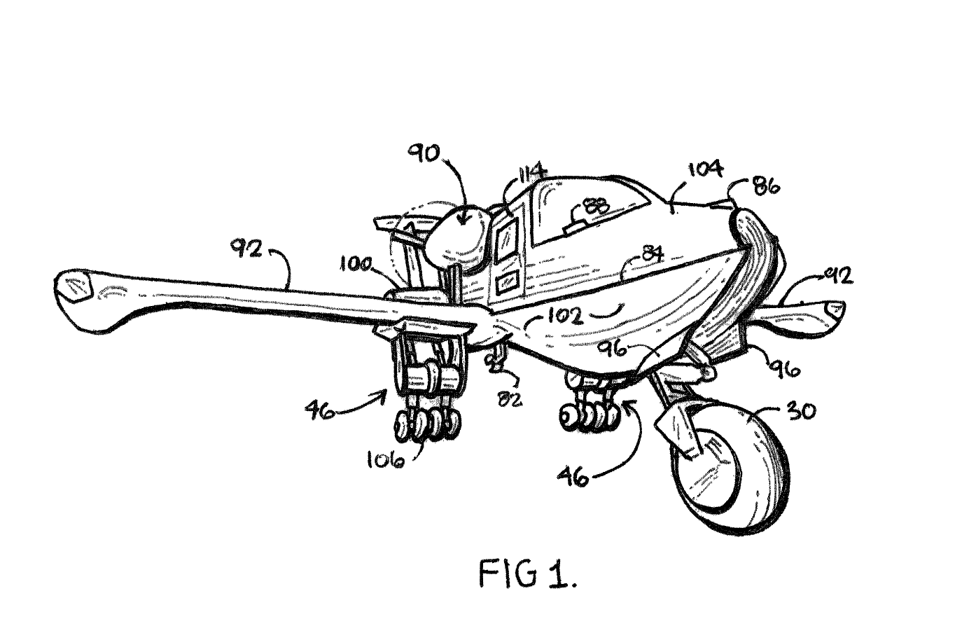

FIG. 1 is a perspective of aircraft landing gear extended. Nose wheel 30 is extended and the partial gear doors 96 are open allowing wheel to be exposed. Hull 102 is separated from upper fuselage 104 by a sidestep 84 that runs at edge as shown. This side step allows water to be preferable dispersed away from aircraft. Water propeller 82 projects below aircraft, supported by a shaft not shown. Main landing gear 46 is extended supported by main landing wheels 106, when retracted it would be concealed by pod 100. Wings 92 have sponsons, and is responsible for main lift. Aircraft is propelled by air propulsion system 90. Dual purpose grab bar is used to secure aircraft to dock or for shimmy with grab bar 88 as disclosed in FIG. 25. 114 is the door to the cockpit.

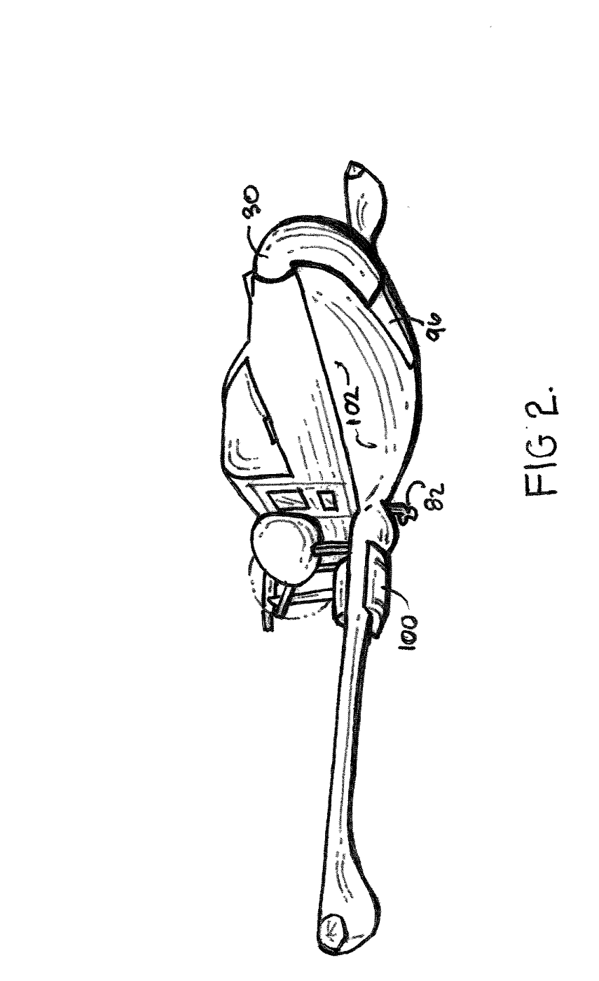

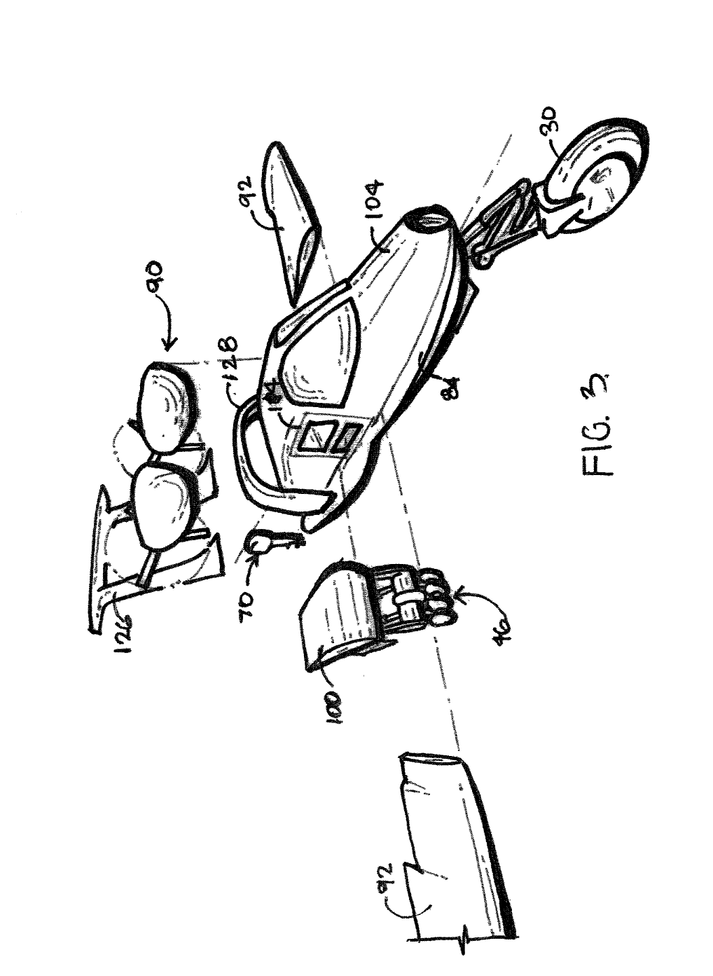

FIG. 2 is a perspective of aircraft landing gear retracted. Nose wheel 30 is retracted and partial gear door 96 is closed. The main landing gear is also retracted into pod 100 as is no longer visible, see FIGS. 12A-12B. this allows aerodynamics to be greatly increased. Water propeller 82 is capable of forward neutral and reverse, and would be set in neutral to minimize drag. The shaft not shown would be as aerodynamic as the vertical stabilizers.

FIG. 3 is an exploded view of aircraft. Rudder elevator assembly 126, air propulsion system 90, wings 92, outboard propeller system 70, side step 84, upper fuselage 104, nose wheel 30, pod 100 and main landing gear 46. 128 is an alternate support for propulsion system. All exploded to show general relationship location.

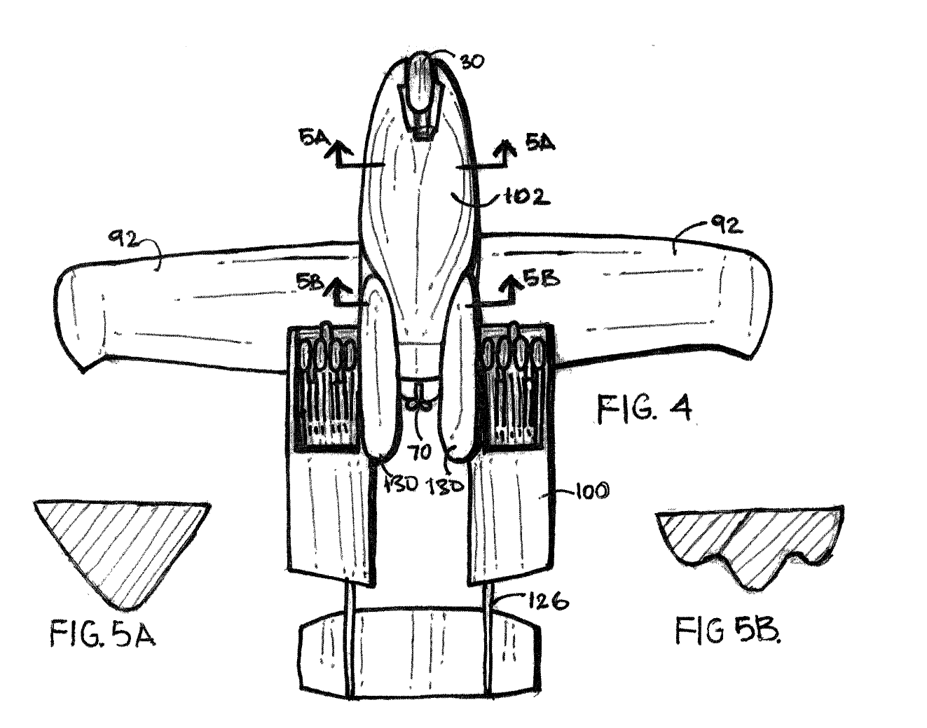

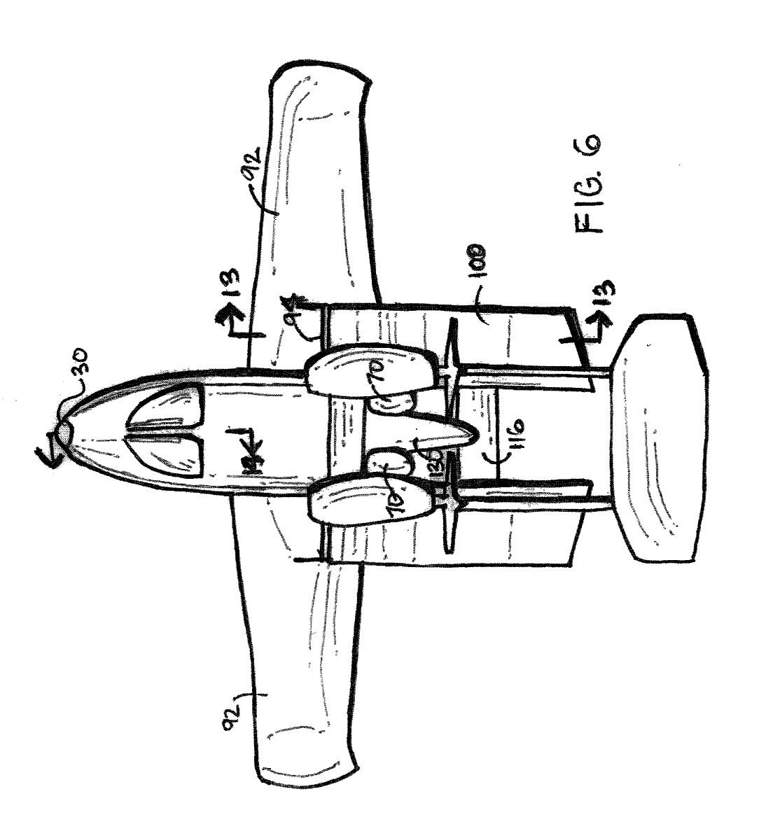

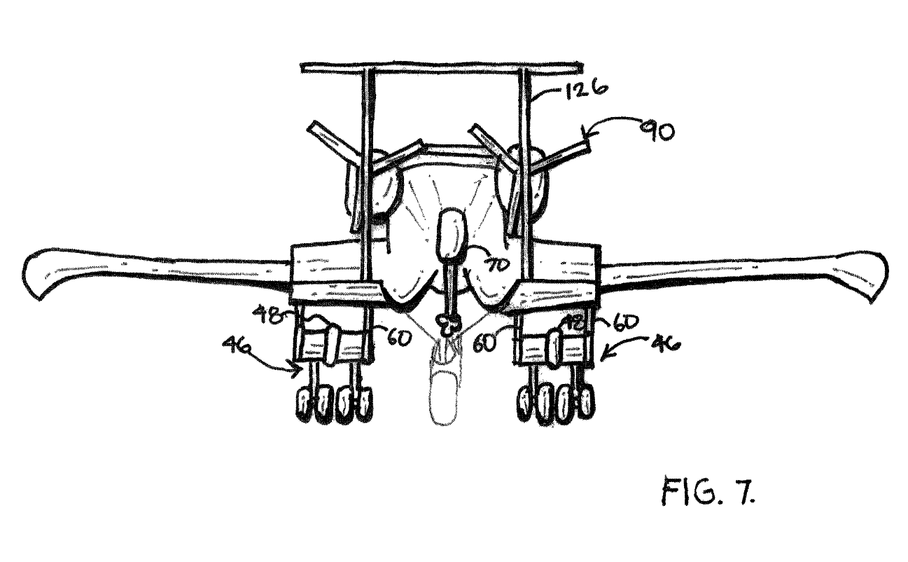

FIG. 4 is a bottom view of aircraft. See FIG. 1. A single outboard propeller system 70 is centrally located as shown. Surrounded by fuselage projections 130. Its understood the length of such projections can vary. See also FIG. 7.

FIGS. 5A-5B is sections of hull of aircraft. 5A is a “V” shaped hull, which merges into 5B, which is “W” shaped hull. Understood that variations are possible without departing from this general classification.

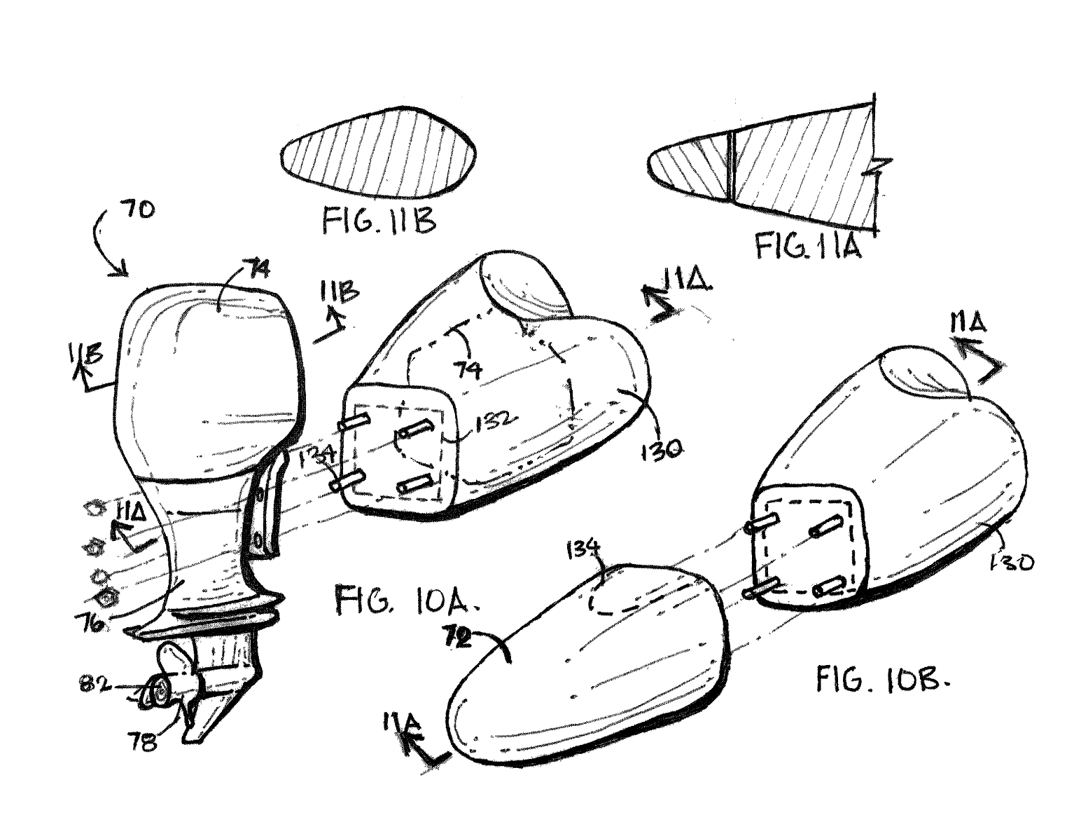

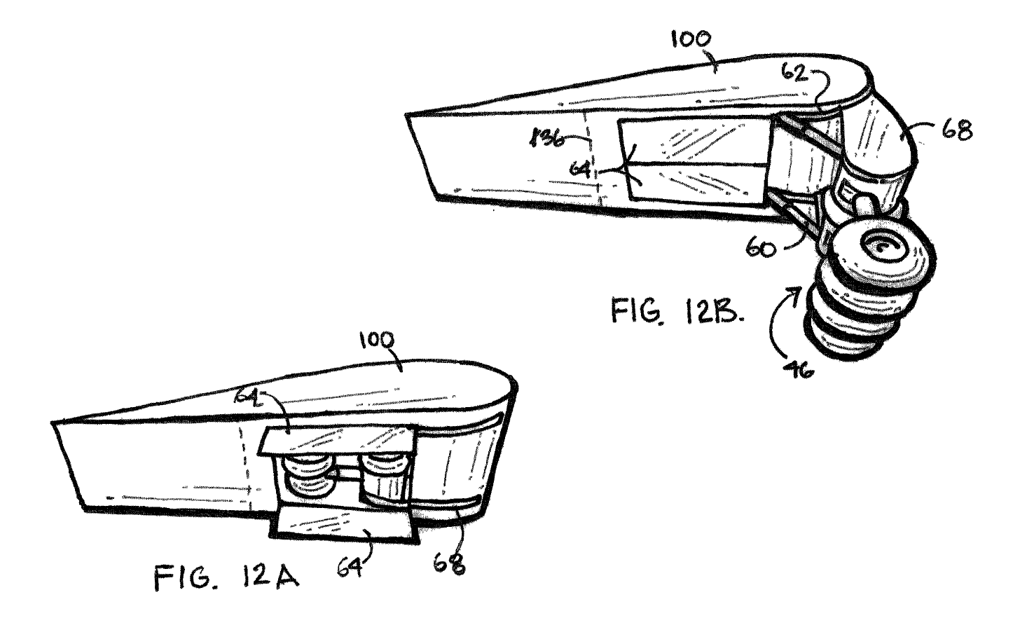

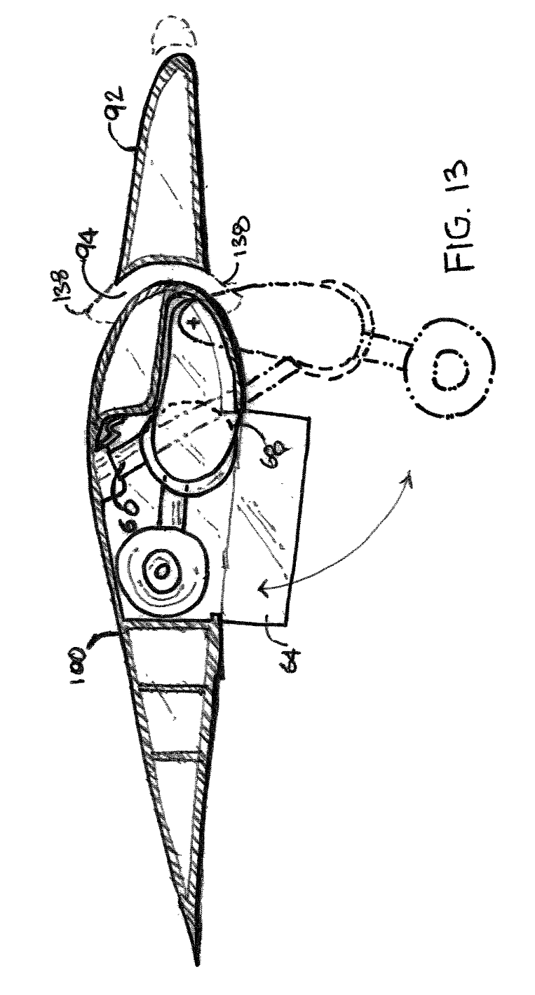

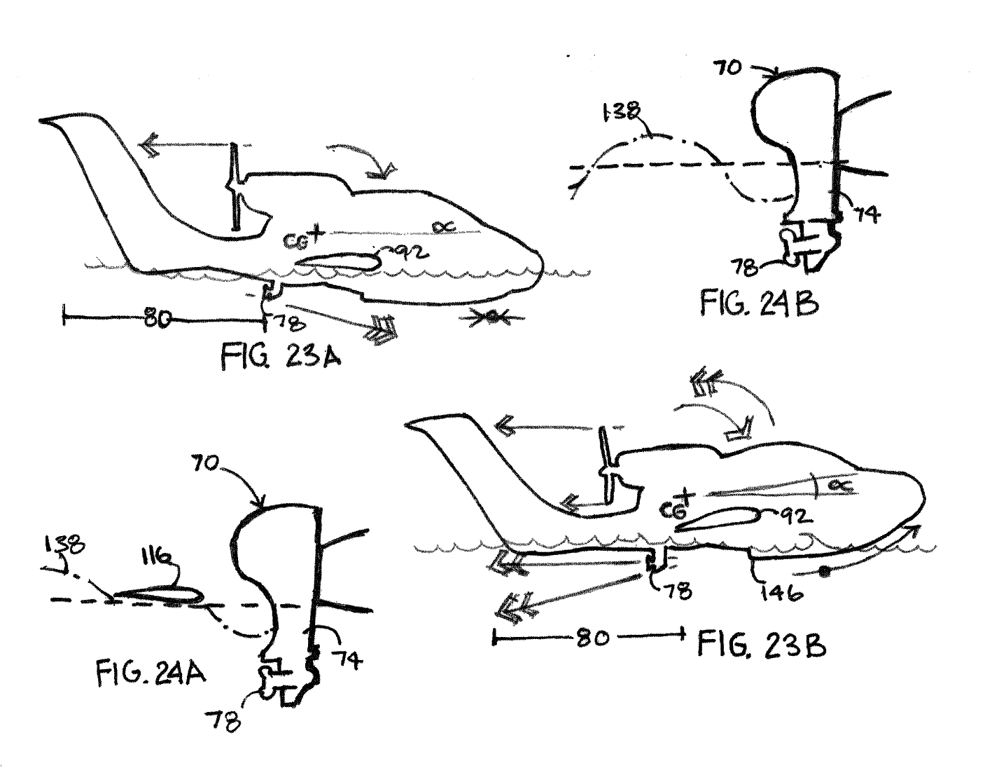

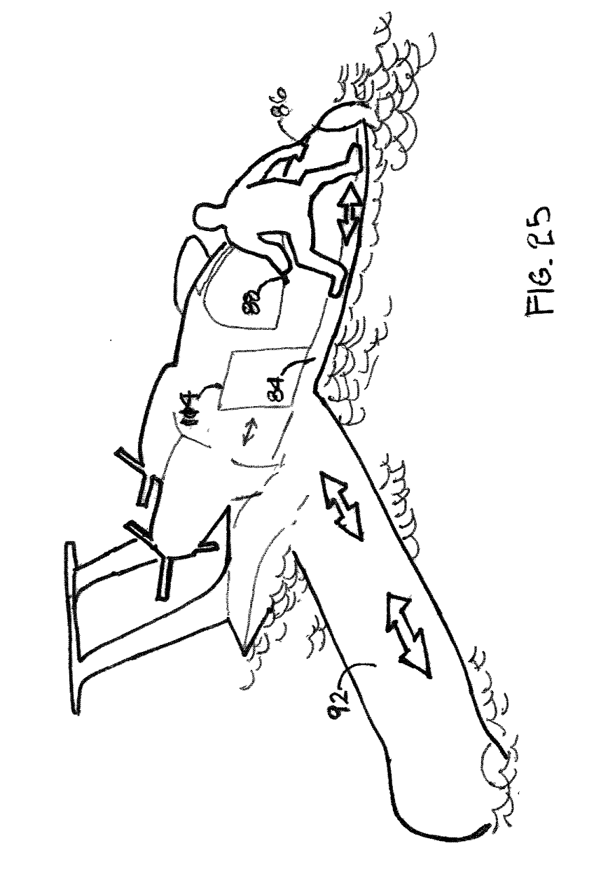

FIG. 6 is top plan view of aircraft with twin outboard propeller system. Wing 92 and pod 100 intersect and sandwich a slot 94 see FIG. 13. 116 is a splash deflector see FIGS. 24A-24B. The splash deflector suppresses splash from outboard engine interfering with air propulsion system also acts as structural support between the two pods. There are two outboard propeller systems 70, symmetrically disposed with a central fuselage projection 130, that can be extended for support for vertical stabilizer.

FIG. 7 is rear elevation with single engine outboard propeller system. The main landing gear 46, shows secondary wheel 48. Extension arm 60 trails behind supporting arm 68 in the groove not shown. See FIGS. 12A-12B.

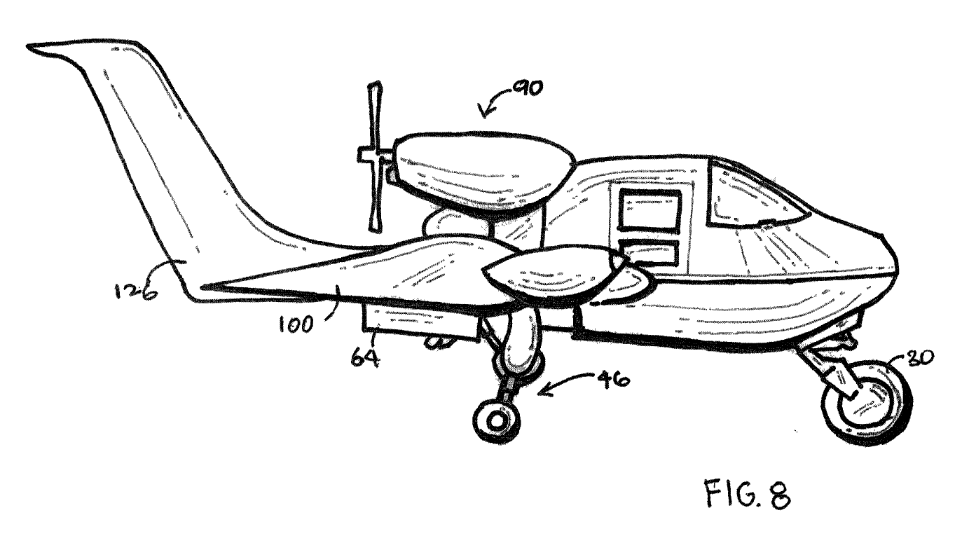

FIG. 8 is side elevation of aircraft. Showing air propulsion system directly above airfoil shaped pod 100. Gear door 64 remains open while main landing gear 46 is extended. So is nose wheel 30. Rudder elevator assembly 126 projects below pod 100 and waterline such that rudder can be used dually for turning in air and water.

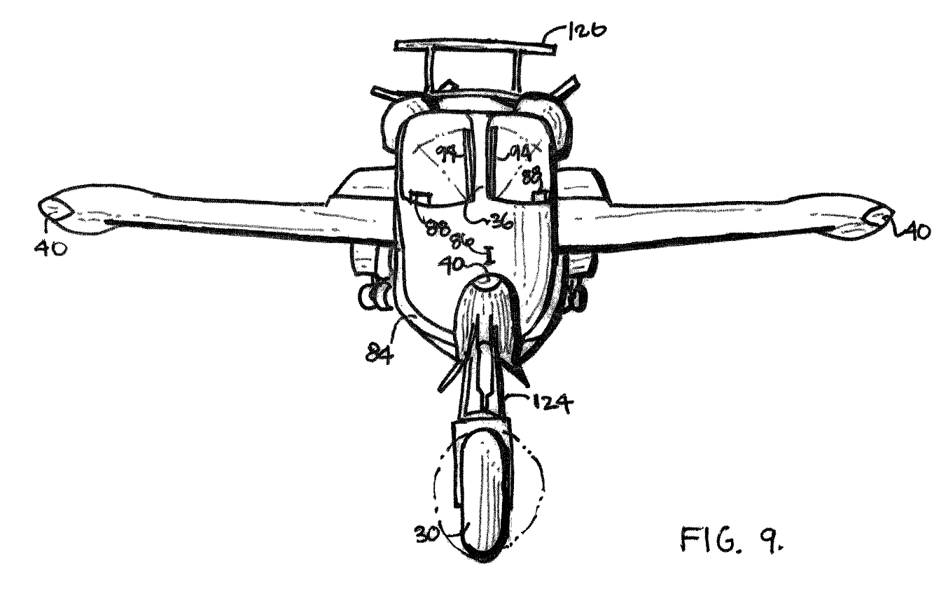

FIG. 9 is a front perspective of aircraft. Landing lights 40 also shown for central position in FIG. 14. the centrally located landing light will improve visibility in adverse weather. 124 is steering cable, that allows wheel 30 to be turned. Steering cable is connected to rudder pedals. Grab bar positions 88 and dual purpose grab bar 86, are also shown. Its understandable that these grab bars can be recessed flush with fuselage but exposed when in use to minimize drag. Side step 84 is also highlighted. Windshield wipers 94 move in highlighted arc over surface relatively uniform in angle and direction, allowing debris from nose wheel to be cleared, also useful in amphibious situations where water spray can cover windshield reducing visibility.

FIGS. 10A-10B is an illustration depicting mounting and replacing outboard propeller system. Outboard propeller engine 74 is shown in alternate positions. Where drag can be reduced. Outboard propeller shaft 76 is naturally aerodynamic and must extend sufficiently below hull that water is free to flow before and after it relatively interrupted. Water propeller 78 shown in normal twist can alternately be reversed optimized instead to operate in reverse as shown in FIGS. 23A-23B. Unlike an air propeller a water propeller can relatively produce the same thrust in reverse. However boats where not designed to operate backwards in reverse and neither is this aircraft, so engines are limited function to produce enough thrust for docking maneuvers. By creating the same gears and electrical system in reverse an outboard propeller system 70 would be able to operate at full power in reverse, to enable holding of the aircraft static as shown if FIGS. 23A-23B.

Outboard propeller system is directly attached to fuselage projection, not transom is used. The overlapping support common for boats is removed and replaced with a built in support backing 132 and hanging hardware 134 which can be other than bolts as suggested in figure. For an inside outside layout drive shat would run directly outside to power propeller shaft axle and hence water propeller. At least the propeller shaft and propeller must remain external.

Entire outboard propeller system 70 can be removed and replaced by a cap 72 that is secured in similar means to fuselage projection 130. Access hatch 134 allows access to securing mechanism and then is shut and is waterproof.

FIG. 11A section showing that both outboard propeller system and cap should have the same cross sectional aerodynamic profile.

FIG. 11B shows a cross section through engine head, showing more aerodynamic cover.

FIGS. 12A-12B is a perspective of main landing gear extending and retracting in pods. When supporting arm 68 and extension arm 60 get into the groove, this allows gear doors 64 to close. This allows laminar flow and lift from the airfoil shaped pod 100 not to be spoiled, also reducing drag. The groove can have a flexible rubber type lining to facilitate water proofing when gear is retracted the front edge of supporting arm 68 fills and seals groove as shown in FIG. 12A. 136 possible position for optional step.

FIG. 13 section trough pod intersecting wing, sandwiching a slot. Showing that landing gear fots within pod 100. Gear door 64 will be able to completely close. Extension arm hydraulically activated extends landing gear into extended position and then retracts using telescoping type tubes. The slot 94 sandwiched by wing 92 and pod 100, allows airflow through and acts to reduce tendency to stall. 138 is a closeable flap is desired to reduce lift. With a air propulsion system directly above airfoil tremendous proportional lift is created even when airfoil is not advancing. When airfoil does advance the proportional lift is reduced. This enables STOL takeoff without limiting top end speed. Its understandable that the slot is optional and not required for basic increase in lift.

FIG. 14 section through nose wheel and actuating members. Wall 140 extends up to point where cantilever suspension and cantilever extension arm retract, its desired that this opening be above water height in event a seal breaks and flood the fuselage. A pivot 142 allows gear to rotate to extended position which is an angle to vertical a. The angle allows the landing gear to be more rugged and further away from aircraft center of gravity affords better stability. Partial gear doors 96 open and allow gear to be extended. A central landing light 40 is also shown. A central structural bar 36 along with wheel absorb and prevent cockpit collapse, the afforded rolling motion induced by the tire also aids in lessening impact force. An airbag in the control yoke 38 deployable on crash impact also aids to survivability of occupants.

FIGS. 15A-15B show blended wheel body, aerodynamic profile. Trying to be illustrated is an uninterrupted parabola curve, where nose wheel 30 blends perfectly with fuselage 102 at any cross section, a blended wheel body.

FIGS. 16A-16C illustrates a nose-wheel under different force scenarios. 16A is resting position, 16B shows a large down force typical to touchdown loads. Cantilever suspension 32 reacts to absorb the force, cantilever extension arm 98 continue to provide support. FIG. 16C shows tire impacting ditch provisionally 15″ high, since the height of clearance 52 which cannot be higher than center of nose wheel 30, is higher than ditch, wheel will eventually go over ditch, but excess impact force is absorbed by direct NW suspension 110. This allows for a smoother running wheel than conventional gear. It is understandable that conventional aircraft wheels do not offer option C.

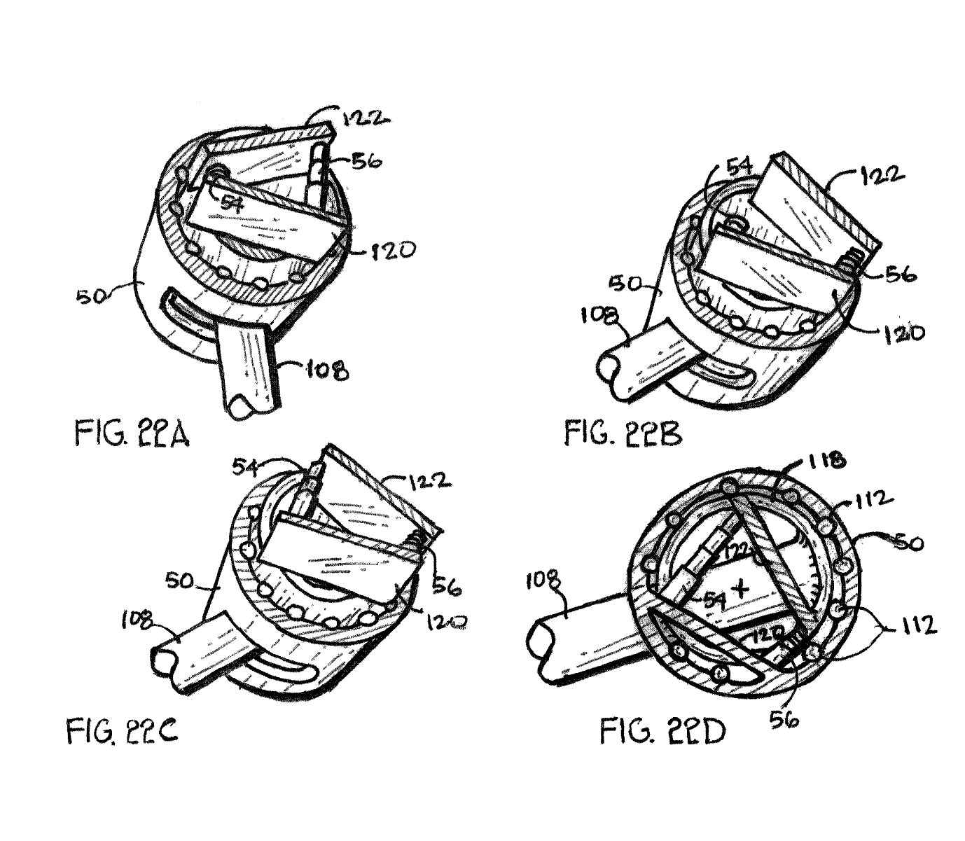

FIGS. 17A-17C illustrates a main landing gear under different force scenarios. The main landing wheels 106 bear the weight of aircraft in resting position 17A. 17B shows a large down force typical of touchdown loads. MLW suspension 108 absorbs the impact. 17C shows the main wheel 106 encountering a provisionally 15″ high ditch, that is higher than height of clearance of main landing wheels 106, suspension in the hub allows wheel secondary wheel to bend closer to the ground engaging surface hence increasing the collective height of clearance of the main landing gear. See FIGS. 22A-22D. It is understandable that conventional aircraft wheels do not offer option C. this allows aircraft to react to the piling of snow sand or just to clear high boundaries and ruts.

FIG. 18. Is a front elevation main landing gear illustrating varying tire size on same axle. This allows less friction with ground on hard surfaces but still allows the width needed on soft and loose terrain where main landing wheel 106 will sink into surface partially. 50 is the hub, 68 the front edge of supporting arm, 48 is the secondary tire and 108 is the MLW suspension.

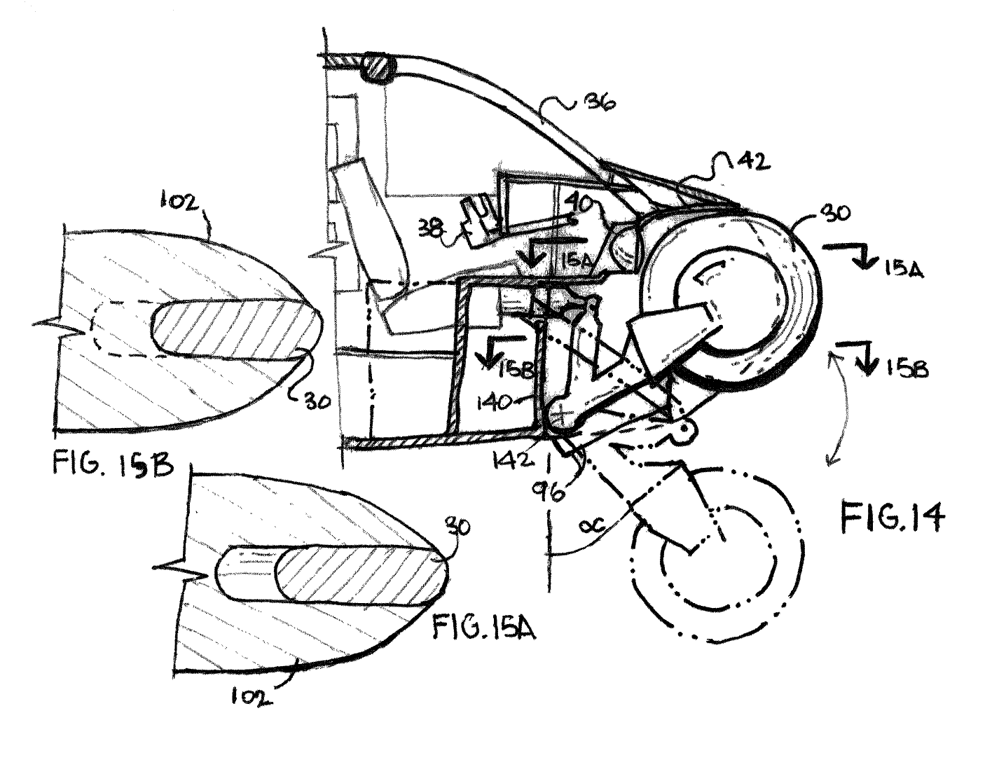

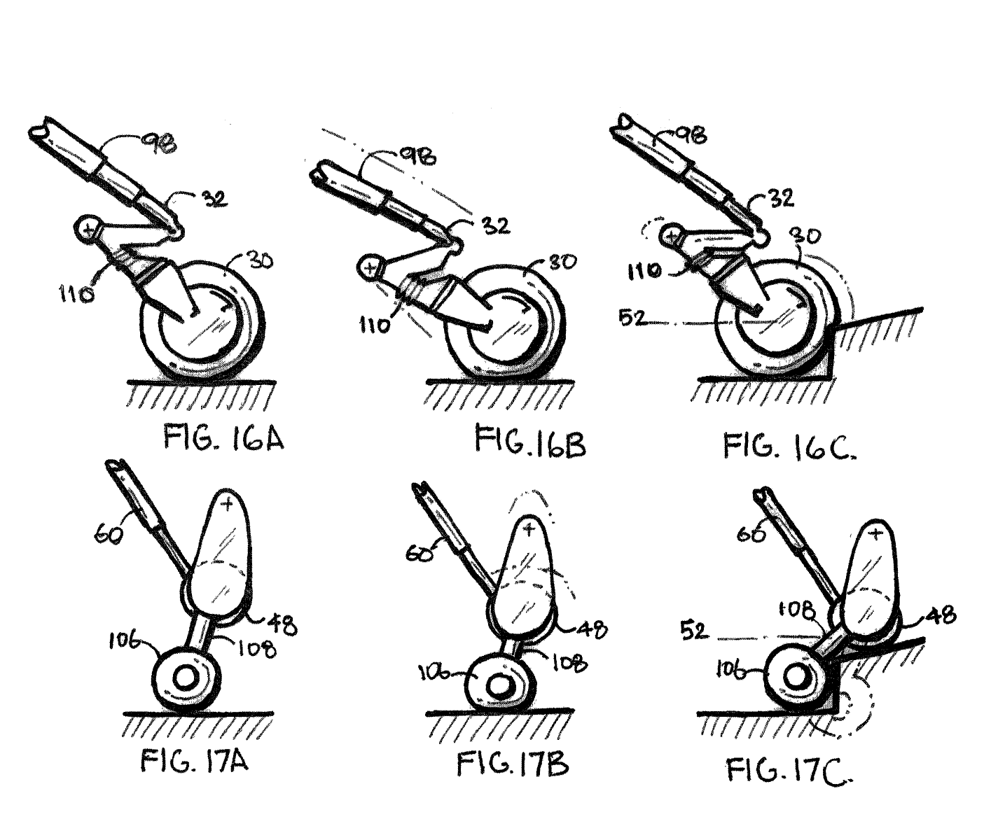

FIG. 19 shows a rounded profile nose-wheel with central rib, where central rib 144 alone comes in contact with hard surface reducing drag.

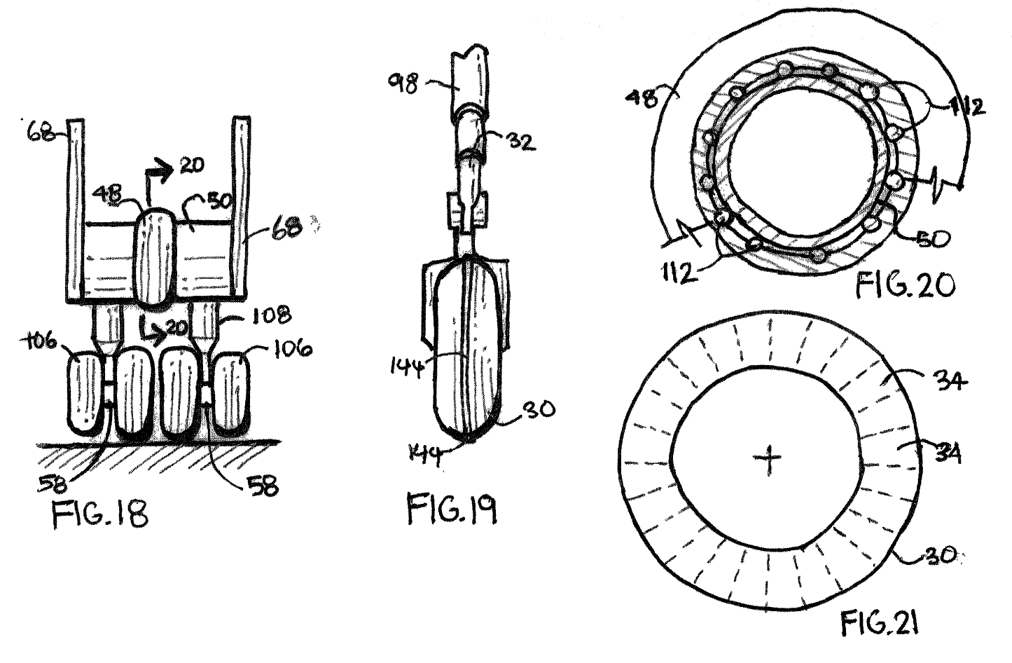

FIG. 20 is a cross section through hub to show secondary wheel rotate-able around the hub by means of bearings 112.

FIG. 21 is a schematic side view of nose wheel, illustrating chambers. Air filled chamber prevent water filling entire tire from a single puncture, also eliminates complete deflation of tire from a single puncture. Increases crash impact absorption power. One-way valves activated by high pressure located in each chamber will allow entire tire to be inflated from one position. The chambers could be the tube rather than tubeless, all are optional.

FIGS. 22A-22B is a series of partial cross section through hub to explain means for suspension and overrides. 56 is suspension member. 122 is inner hub plate connected to inner hub 118. 120 is hub plate connected to hub 50. When inner hub rotate by force transmitted up by main gear suspension 108, 56 suspension member is compressed FIG. 22B and will recoil to normal when the force that moved 108 subsides. If 54 override member is extended 22C by hydraulic action it prevents the suspension from returning wheel to initial position 22B. By means of bearing 112 internal hub rotates within hub.

FIGS. 23A-23B illustrates use of outboard propeller as auxiliary power for takeoff. 23A shows the aircraft being held static by two opposing forces, air forces and resultant turning force is represented by single head arrows while water forces and resultant by double head arrows. The purpose of holding the aircraft for a period is to allow main propellers to attain a desired momentum, hence reducing takeoff run when aircraft is turned loose. The shape of the hull encourages nose up tendency when aircraft reaches a certain speed regardless of forces offset from the center of gravity (CG). wing 92 will be raised instantly when aircraft is turned loose, due to sudden burst of energy, all this facilitating a shorter takeoff FIG. 23B. Also shown in FIG. 23B is the water propeller 78 now switched to forward thrust. This not only help to raise nose out of water instantly due to its disposition to CG, but also breaks up the laminar flow of water and associated tension that holds aircraft down for the rear portion of aircraft 80. This is assisted by the exhaust to create turbulence in the water the same function a step 146 does. Therefore propeller shaft is lower than rear portion of aircraft.

FIGS. 24A-24B illustrates splash deflector. Suppressing splash wave 138 from interacting with air propulsion system.

FIG. 25 a perspective of how to use side step, by holding grab bar 88 and dual purpose grab bar 86, the figure can shimmy along side step as shown, from the door 114 to the nose. The positioning will not be difficult and should be easier than other positioning adults put themselves in for fin. It is also possible to exit from door 114 and walk on the wing 92.

What I claim as my invention is:

1. An aircraft landing gear system, comprising.
a. A tricycle gear layout, a pivot-ably nose-wheel, and main landing gears substantially symmetrically opposed. Said nose-wheel is an oversized tire.
b. A fuselage, where said nose-wheel protrudes partially from front of said fuselage when retracted forming the nose of the aircraft. Whereby aerodynamics is enhanced and drag is reduced.

2. The nose wheel of claim 1, wherein a cantilever suspension allows thereof being disposed at an angle from vertical to said pivot when filly extended. Whereby the greater distance from center of gravity allows better stability and ruggedness of thereof.

3. The nose-wheel of claim 1, where tire is subdivided into chambers. Whereby tire will not be susceptible to a single puncture.

4. The oversized nose-wheel of claim 1, in conjunction with a central structural bar, absorbs and distributes crash impact forces more evenly throughout aircraft airframe, increasing the survivability of the same. An airbag in a control yoke in the front seats of aircraft is deployed at crash impact. Whereby providing further protection for occupants.

5. The partially protruding nose-wheel of claim 1, where profile is substantially rounded, where wheel and nose blend together substantially. A blended wheel body. Whereby aerial drag and ground friction on hard surfaces is reduced. A partial gear door opens and close allowing said pivot-able nose-wheel to blend with fuselage and still be able to be extended.

6. The nose wheel of claim 1, where a landing light is attached relatively to the upper inside portion of forward wheel well. A pivot-able windshield wiper that is mounted adjacent to central structural bar. Whereby visibility in adverse weather conditions is improved, especially when said nose wheel contains debris that may get loose and hit windshield.

7. The main landing gear of claim 1, consisting of a plurality of main wheels, that are pivot-able around as a means for allowing said hub to be lowered. At-least one secondary wheel rotate-able around said hub collectively with main wheels raise the main landing gear height of clearance.

8. The main landing gear of claim 1 where thereof can rotate about itself, at a hub. Where if the main wheel strikes an object it can rotate and change angle of attack by use of suspension member within hub that returns wheel position after impact. The said hub also contains an overriding member that works in opposition to said suspension member, thereby overriding suspension. Whereby allowing the angle of attack of said main wheels to be manually changed and allowing aircraft lowering its height to allow easier loading and unloading of said aircraft.

9. The main landing gear of claim 1, consisting of varying wheel sizes on same axle where the larger wheels bear the weight of aircraft on hard surfaces as smaller wheels are elevated higher because of reduced diameter. Whereby drag is reduced but allowing tires to come in contact only in loose or rough terrain or when aircraft is at a side angle.

10. The main landing gear of claim 1, completely retractable into a pod. A supporting arm with little forward area pivots within said pod. Extension arms follow in the path of supporting arm, which runs in a groove in the pod when extended, extension arms follow. A gear door opens and allows main landing gear to rotate pivotally into groove. When completely extended the gear doors close and seal the gear well gap, while the extension arm and supporting arm remain external in said groove. Said gear doors open and close again to allow full retraction of said main landing gear. Said groove is filled by the exposed leading edge of a supporting arm upon retraction. Whereby drag induced by extended landing gear is reduced and laminar airflow over pod is only briefly interrupted.

11. A flying boat auxiliary propulsion system on water, comprising.
a. A fuselage
b. An outboard propeller system consisting of at-least a shaft and a water propeller attached to the aft end of said fuselage.

12. The outboard propeller system of claim 11, where said engine is mounted externally with propeller shaft and water propeller on a hard point. Said outboard engine is removable and replaceable with a cap. Whereby weight can be removed when not in use, and aerodynamics can be improved.

13. The outboard propeller system of claim 11, where said engine is mounted within fuselage.

14. The outboard propeller system of claim 11, where reverse gears are substantially structurally similar to forward gears enabling outboard propeller to deliver substantially similar thrust in reverse as in forward gears. As a means for holding aircraft in stationary position when air propellers thrust match thrust of reverse thrust of outboard propeller. Whereby air propeller can achieve a certain momentum before commencing take off run, in effect reducing the acceleration time and takeoff distance when reverse thrust is cut and main engines advanced simultaneously to maximum throttle.

15. The said shaft of claim 11, which extends substantially below rear portion of aircraft. A propeller with exhaust in the center attached to said shaft operated in forward gear. Whereby the turbulent wake of the propeller assisted by the exhaust breaks up the laminar flow of water under said rear portion of aircraft that rests in the water, in effect accelerating the aircraft breaking free from the tension hold of the water at takeoff.

16. The said fuselage of claim 11 where forward cross-section is substantially “V” shaped, and aft section is substantially “w” shaped. Where a hard-point is possible on each projection at each of the ends of the fuselage.

17. The said fuselage of claim 11, where lower portion of fuselage, a hull is staggered from upper portion by a relatively flat sidestep. Said sidestep extends at least from a door where individual enter or exit aircraft to nose of aircraft. Thereof treated with non-slip surface. A dual-purpose grab bar at the nose and additionally a grab bar located further up the nose of aircraft substantially midway between cockpit door and nose of aircraft. Whereby individuals in aircraft can shimmy along side step for accessing the dock and or dual-purpose grab bar for securing aircraft to dock.

18. A aircraft lifting body system comprising,
a. A pod, which is a substantially thick and narrow airfoil.
b. An air propulsion system mounted above each said pod. Where there are two number said pods symmetrically disposed to each other, on the left and right side of the aircraft. Where said pods form an aft-extended portion of an aircrafts body. Whereby the contrail of said air propulsion system over the pods create substantial lift not possible if they where apart.

19. The pod of claim 18, a fuselage, said pods attached to said fuselage. A wing attached to said fuselage. Wing produces the main lift and pods are short relatively as wide as the contrail of the propulsion system provides auxiliary lift. Whereby pods create instantaneous lift when air propulsion system activated, while wing awaits forward motion of aircraft, as the motion of aircraft increases so the reduction in proportionate lift from pods. This affords STOL at takeoff without limiting aircraft top end speed.

20. The pod of claim 18 where a wing and said pod intersect. Sandwiching a slot is where the leading edge of airfoil of the pod intersects with said wing. A fuselage with the said wing base attached to it. Slot acts as a leading edge slot. Whereby the pod stall speed is reduced.
